(19) United States
(12) Patent Application Publication
(10) Pub. No.: US 2023/0062676 A1
(43) Pub. Date: Mar. 2, 2023

(54) MOBILE ROBOT ASSEMBLY AND SYSTEM FOR UNLOADING PARCELS FROM A CARGO AREA

(71) Applicant: Material Handling Systems, Inc., Mt. Washington, KY (US)

(72) Inventors: Madhav Devidas Patil, Louisville, KY (US); Thomas Anthony Hillerich, JR., Louisville, KY (US); Paul Receveur, New Albany, IN (US); Jonathan Dean Terrell, Louisville, KY (US)

(21) Appl. No.: 17/895,537

(22) Filed: Aug. 25, 2022

Related U.S. Application Data
(60) Provisional application No. 63/237,285, filed on Aug. 26, 2021.
(60) Provisional application No. 63/352,807, filed on Jun. 16, 2022.

(51) Int. Cl. B65G 1/137

(52) U.S. Cl. CPC B65G 1/1375

(57) ABSTRACT

A system for unloading parcels from a cargo area includes: an extendible conveyor; a transfer conveyor for conveying parcels to the extendible conveyor; and a mobile robot assembly configured to engage and transfer parcels in the cargo area onto the transfer conveyor. The mobile robot assembly repeatedly advances and transfers parcels in the cargo area to the transfer conveyor. As the mobile robot assembly advances within the cargo area, the transfer conveyor and the extendible conveyor follow to provide a pathway along which parcels transferred by the mobile robot assembly can be transferred out of the cargo area. The mobile robot assembly includes: a mobile base for repositioning the mobile robot assembly; a framework mounted to the mobile base; a first robot and a second robot, each mounted for vertical movement with respect to the framework and configured to engage and transfer parcels; and a vision and control subsystem.

### CROSS-REFERENCE TO RELATED APPLICATIONS

The present application claims priority to: U.S. Patent Application Ser. No. 63/237,285 filed on Aug. 26, 2021; and U.S. Patent Application Ser. No. 63/352,807 filed on Jun. 16, 2022, the entire disclosures of which are incorporated herein by reference.

### BACKGROUND OF THE INVENTION

The present invention relates to a mobile robot assembly and system for unloading parcels from a cargo area, such as that defined by the trailer portion of a tractor-trailer.

In commercial shipping, loading bays are used to facilitate the loading of parcels from a shipping facility into the cargo area of a transport vehicle (e.g., the trailer portion of a tractor-trailer) and/or the unloading of parcels from the cargo area of the transport vehicle into the shipping facility. In this regard, a loading bay typically corresponds to an entryway defined in the side of a building to which the cargo area of a transport vehicle can be brought in close proximity. For instance, in many loading and unloading applications, the trailer portion of a tractor trailer is backed toward a loading bay until the trailer portion of the tractor trailer engages one or more bumpers positioned on the exterior of the loading bay, thereby creating a slight gap between the loading bay and the trailer portion of the tractor trailer, which is subsequently bridged (e.g., via a dock leveler or dock plate). Traditionally, manual labor has been employed to place parcels in and remove parcels from the cargo area of transport vehicles. However, manually unloading parcels is often a time-consuming and labor-intensive process. Thus, various systems have been developed to assist in unloading parcels, which include, for example, conveyors and a robotic arm. However, such prior art systems are not always effective or efficient, in part, because the configurations of the parcels within the cargo area of a transport vehicle often varies and is unpredictable. Furthermore, some prior art systems require modifications to the trailers, which is often impractical and/or cost-prohibitive.

Accordingly, there remains a need for a mobile robot assembly and improved system for unloading parcels from a cargo area.

### SUMMARY OF THE INVENTION

The present invention is a mobile robot assembly and system for unloading parcels from a cargo area.

An exemplary system for unloading parcels from a cargo area made in accordance with the present invention includes: an extendible conveyor configured to extend into the cargo area and to convey parcels loaded onto a distal end of the extendible conveyor toward a proximal end of the extendible conveyor; a transfer conveyor for conveying parcels loaded thereon to the distal end of the extendible conveyor; and a mobile robot assembly configured to engage and transfer parcels in the cargo area onto the transfer conveyor. In use, the mobile robot assembly first advances into the cargo area until reaching a location in which one or more parcels are within a predetermined (or reaching) distance of the mobile robot assembly. The transfer conveyor and the extendible conveyor follow the mobile robot assembly as the mobile robot assembly advances within the cargo area to provide a pathway along which parcels engaged and transferred by the mobile robot assembly can be conveyed out of the cargo area. Once the pathway defined by the transfer conveyor and the extendible conveyor is established, the mobile robot assembly commences transferring parcels to the transfer conveyor, which, in turn, then transfers such parcels onto the extendible conveyor. Once all of the parcels within reach of the mobile robot assembly 40 have been unloaded from the cargo area, or at least deposited onto the extendible conveyor, the foregoing advance-transfer process is repeated until all parcels within the cargo area have been transferred by the mobile robot assembly.

The mobile robot assembly includes: a mobile base for repositioning the mobile robot assembly within the cargo area; a framework mounted to the mobile base; a first robot and a second robot, each mounted for vertical movement with respect to the framework and configured to engage and transfer parcels within the cargo area onto the transfer conveyor; and a vision and control subsystem.

The vision and control subsystem includes one or more cameras for acquiring images of parcels located in the cargo area and a controller that includes a processor for executing instructions stored in a memory component to receive and process image data corresponding to the images obtained by the one or more cameras and selectively communicate instructions to the first robot and the second robot which cause the first robot and the second robot to transfer parcels based on the image data.

In some embodiments, the vision and control subsystem includes at least one camera mounted to the framework, a camera mounted to the end effector of the first robot, and a camera mounted to the end effector of the second robot. To regulate vertical movement of the first robot and the second robot along the framework, in some embodiments, the mobile robot assembly further includes a first actuator and a second actuator. The first actuator is operably connected to the vision and control subsystem and is configured to reposition the first robot along the framework. Similarly, the second actuator is operably connected to the vision and control subsystem and configured to reposition the second robot along the framework. In such embodiments, the memory component of the controller further includes instructions which, when executed by the processor, cause the controller to selectively communicate instructions to the first actuator and the second actuator to reposition the first robot and the second robot, respectively, along the framework based on the image data.

In some embodiments, the first robot and the second robot each comprise a robotic arm and an end effector for engaging parcels mounted to the distal end of the robotic arm. In some embodiments, the robotic arm of the first robot and the second robot is a six-axis articulating robotic arm. In some embodiments, the end effector of the first robot and the second robot includes an array of vacuum cups. In such embodiments, the vision and control subsystem is preferably operably connected to a vacuum and control subsystem which can selectively place selected vacuum cups of the end effector of the first robot and the end effector of the second robot in fluid communication with a vacuum source based on instructions communicated from the controller.

In some embodiments, the transfer conveyor is mounted to at least one of the mobile base and the framework. In such embodiments, the transfer conveyor may thus be characterized as a component of the mobile robot assembly.

In some embodiments, to aid the mobile robot assembly in initially navigating to and subsequently within the cargo area, the mobile base includes one or more sensors that are operably connected to the vision and control subsystem and configured to obtain readings regarding the presence of objects around the mobile base that are within the field of view of the one or more sensors. The controller can communicate instructions which cause the mobile base to reposition the mobile robot assembly within the cargo area based on the readings from the one or more sensors of the mobile base and/or image data corresponding to images obtained by the cameras of the vision and control subsystem. In some embodiments, the mobile base includes omnidirectional wheels which enable the mobile base to move the mobile robot assembly in any direction.

In another embodiment, the mobile robot assembly is configured to transfer parcels in the cargo area directly onto the extendible conveyor. Accordingly, in such an embodiment, the system includes each of the system components described above, except for the transfer conveyor.

In alternative embodiments and implementations, the mobile robot assembly and system of the present invention may be used to load parcels into a cargo area.

### DESCRIPTION OF THE DRAWINGS

FIG. 1A is a perspective view of a system for unloading parcels from a cargo area, including an exemplary mobile robot assembly made in accordance with the present invention positioned within the cargo area;

FIG. 1B is a perspective view of the system for unloading parcels similar to FIG. 1A, but with the exemplary mobile robot assembly positioned at a different location within the cargo area;

FIG. 2 is a perspective view of the exemplary mobile robot assembly of FIGS. 1A and 1B;

FIG. 3 is a schematic diagram of a vision and control subsystem of the exemplary mobile robot assembly of FIGS. 1A and 1B;

FIG. 4 is a flow chart illustrating an exemplary routine for initializing the exemplary mobile robot assembly of FIGS. 1A and 1B to unload the cargo area;

FIG. 5 is a flow chart illustrating an exemplary parcel transfer routine;

FIG. 6 is a diagram illustrating movement cycles performed by a first robot and a second robot of the exemplary mobile robot assembly of FIGS. 1A and 1B to transfer parcels from the cargo area to a transfer conveyor;

FIG. 7 is a top view of a portion of the cargo area of FIG. 1A; and

FIG. 8 is a schematic diagram of an alternative mobile base which may be used in the mobile robot assembly of FIGS. 1A and 1B.

### DETAILED DESCRIPTION OF THE INVENTION

The present invention is a mobile robot assembly and system for unloading parcels from a cargo area.

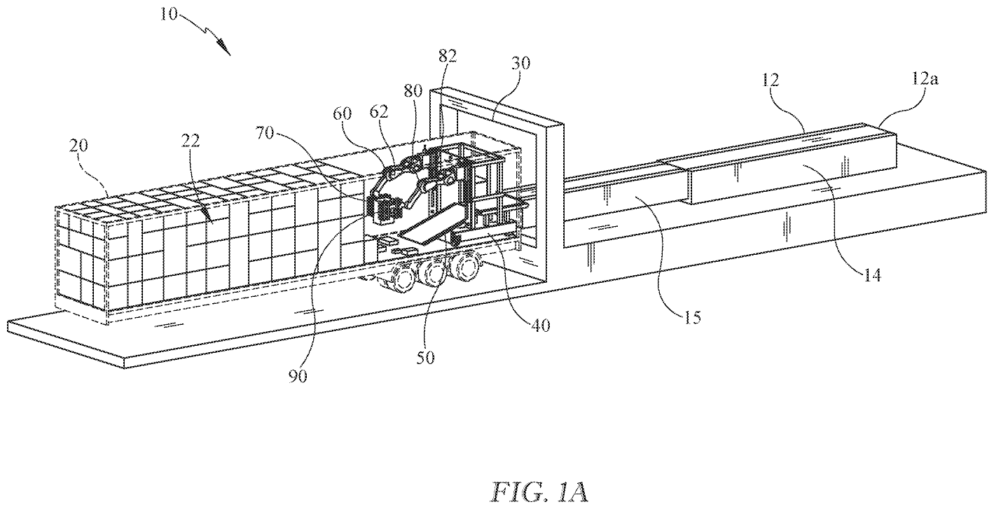

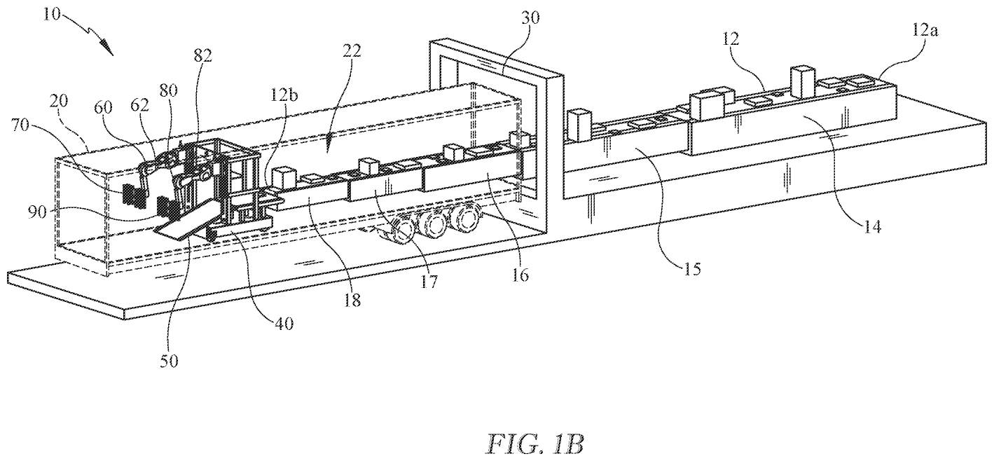

FIG. 1A is a perspective view of a system 10 for unloading parcels from a cargo area 22, including an exemplary mobile robot assembly 40 made in accordance with the present invention positioned within the cargo area 22.

FIG. 1B is a perspective similar to FIG. 1A, but with the exemplary mobile robot assembly 40 positioned at a different location within the cargo area 22.

Referring now to FIGS. 1A and 1B, in this exemplary embodiment, the system 10 includes: an extendible conveyor 12 configured to extend through a loading bay 30 of a building and into the cargo area 22 and to convey parcels loaded onto a distal end 12b of the extendible conveyor 12 toward a proximal end 12a of the extendible conveyor 12 for subsequent processing; a transfer conveyor 50 for conveying parcels loaded thereon to the distal end 12b of the extendible conveyor 12; and a mobile robot assembly 40 configured to engage and transfer parcels in the cargo area 22 onto the transfer conveyor 50. When the system 10 is in use, the mobile robot assembly 40 first advances into the cargo area 22 until reaching a location in which one or more parcels are within a predetermined (or reaching) distance of the mobile robot assembly 40, and, more specifically, a first robot 60 and/or second robot 80 thereof, at which time the mobile robot assembly 40 will cease advancing. The transfer conveyor 50 and the extendible conveyor 12 follow the mobile robot assembly 40 into the cargo area 22 to provide a pathway along which parcels engaged and transferred by the mobile robot assembly 40 can be conveyed out of the cargo area 22. Once the pathway defined by the transfer conveyor 50 and the extendible conveyor 12 is established, the mobile robot assembly 40 commences transferring the parcels within reach onto the transfer conveyor 50, which then transfers such parcels onto the extendible conveyor 12. Once all of the parcels within reach of the mobile robot assembly 40 have been unloaded from the cargo area 22, or at least deposited onto the extendible conveyor 12, the above advance-transfer process is repeated until all parcels within the cargo area 22 have been transferred by the mobile robot assembly 40.

Referring still to FIGS. 1A and 1B, in this example, the cargo area 22 is defined by a trailer portion 20 (indicated in broken lines) of a tractor trailer that is configured to be pulled by the tractor portion (not shown) of the tractor trailer. It is important to recognize, however, that the mobile robot assembly 40 and the system 10 disclosed herein may be utilized to unload parcels from different cargo areas without departing from the spirit and scope of the present invention. For instance, in some implementations, the mobile robot assembly 40 and system 10 may be utilized in the unloading of cargo areas defined by other transport vehicles, e.g., vans, box trucks, etc., while, in other implementations, the mobile robot assembly 40 and system 10 may be utilized in the unloading of cargo areas within a building or other structure. It is also important to recognize that, in the discussion that follows and in the claims of the present application, the term “parcel” is not intended to be limiting and can include any article, item, or object that may be engaged, transferred, loaded, and/or unloaded in the manner specified within the present disclosure.

Referring still to FIGS. 1A and 1B, in this exemplary embodiment, the extendible conveyor 12 includes multiple telescoping sections 14, 15, 16, 17, 18 and is configured to transition between a retracted configuration (not shown) and an extended configuration (FIGS. 1A and 1B) to affect the length of the extendible conveyor 12. When the extendible conveyor 12 is in the retracted configuration, the telescoping sections 14, 15, 16, 17, 18 are in a generally stacked (or nested) orientation relative to each other. Conversely, and as shown in FIGS. 1A and 1B, when the extendible conveyor 12 is in the extended configuration, some (FIG. 1A) or all (FIG. 1B) of the telescoping sections 14, 15, 16, 17, 18 are linearly arranged along a horizontal plane to define a pathway leading to the transfer conveyor 50. Each respective telescoping section 14, 15, 16, 17, 18 defines a conveying surface, such as a belt or plurality of rollers, that can be selectively activated while the extendible conveyor 12 is in the extended configuration to convey parcels loaded onto the extendible conveyor 12 downstream toward the mobile robot assembly 40. In this exemplary embodiment, there are five such telescoping sections 14, 15, 16, 17, 18 although additional or fewer telescoping sections could be incorporated into the extendible conveyor 12 without departing from the spirit and scope of the present invention. One suitable conveyor which may be utilized as the extendible conveyor 12 is the extendible belt conveyor described in U.S. Pat. No. 10,926,958, which is incorporated herein by reference.

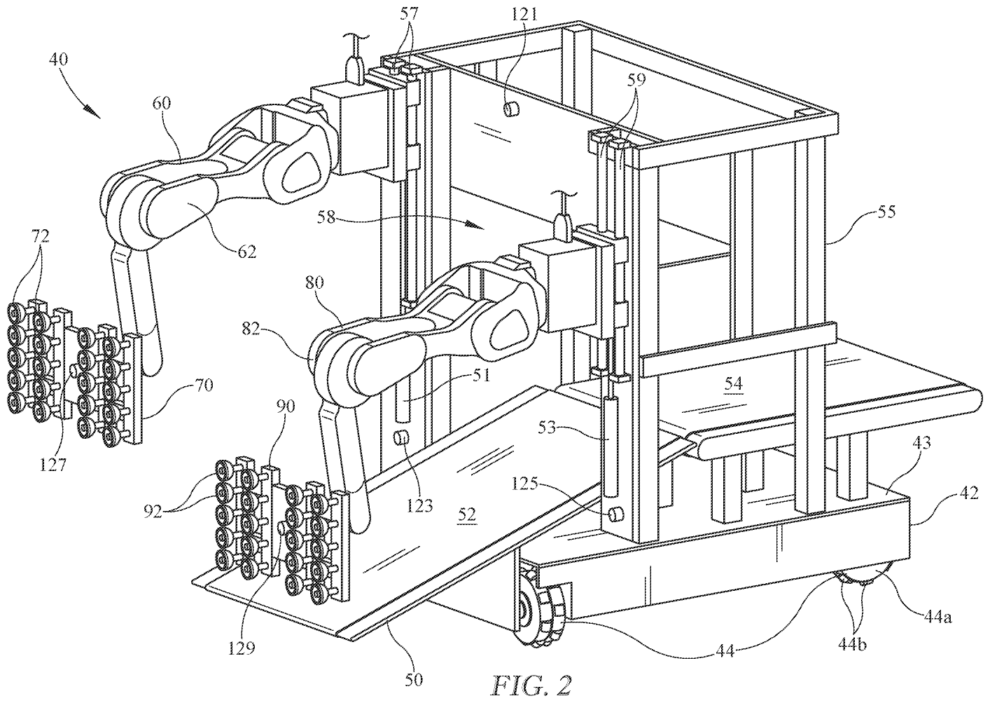

FIG. 2 is a perspective view of the mobile robot assembly 40.

Referring now to FIGS. 1A, 1B, and 2, in this exemplary embodiment, the mobile robot assembly 40 includes: a mobile base 42 configured to reposition the mobile robot assembly 40 within the cargo area 22; a framework 55 mounted to the mobile base 42; a first robot 60 mounted for vertical movement with respect to the framework 55 and configured to engage and transfer parcels within the cargo area 22 onto the transfer conveyor 50; a second robot 80 mounted for vertical movement with respect to the framework 55 and configured to engage and transfer parcels within the cargo area 22 onto the transfer conveyor 50; and a vision and control subsystem 100 that obtains and processes images corresponding to the environment around the mobile robot assembly 40 and selectively communicates instructions to affect the operation of certain components of the mobile robot assembly 40, as further described below. As shown, in this exemplary embodiment, the transfer conveyor 50 is mounted to at least one of the mobile base 42 and the framework 55, such that, as the mobile base 42 moves, the transfer conveyor 50 also moves. In this regard, the transfer conveyor 50 may thus be characterized as a component of the mobile robot assembly 40. That is, in this exemplary embodiment, the mobile robot assembly 40 includes the transfer conveyor 50.

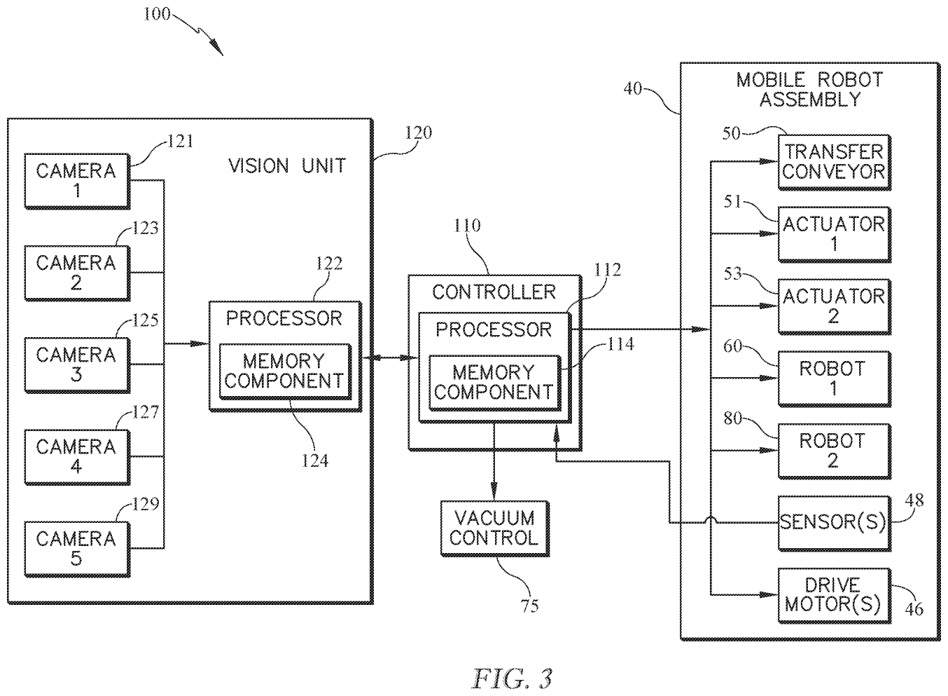

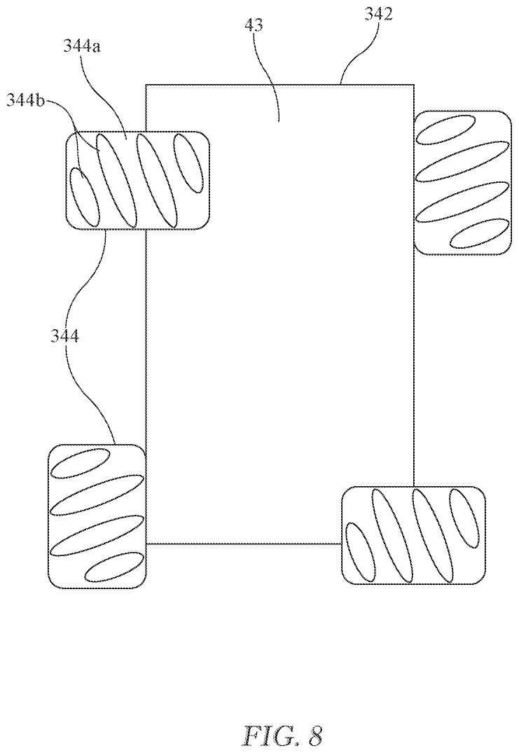

Referring now specifically to FIG. 2, in this exemplary embodiment, the mobile base 42 of the mobile robot assembly 40 includes: a body 43; a plurality of wheels 44 mounted for rotation with respect to the body 43; and one or more drive motors 46 (FIG. 3) for driving rotation of the wheels 44. The mobile base 42 includes four wheels 44, two of which are visible in FIG. 2. Specifically, in this exemplary embodiment, each wheel 44 of the mobile base 42 is an omnidirectional wheel to enable the mobile base 42, and thus the mobile robot assembly 40 as a whole, to move in any direction. In this regard, each respective wheel 44 includes: a primary hub 44a that is operably connected to, and configured to be driven by, a drive motor of the one or more drive motors 46 to direct the mobile base 42 in a first direction of travel; and a plurality of rollers 44b that are integrated into, and mounted for rotation with respect to, the primary hub 44a to enable the mobile base 42 to move in a second direction of travel that is perpendicular to the first direction of travel. Of course, the plurality of rollers 44b may be alternatively integrated into, and mounted for rotation with respect to, the primary hub 44a without departing from the spirit and scope of the present disclosure, as evidenced, e.g., by the mobile base 342 embodiment described below with reference to FIG. 8.

Referring still to FIG. 2, in this exemplary embodiment, the primary hub 44a of two of the four wheels 44 (e.g., the rear-right wheel and front-left wheel) is mounted for rotation with respect to the body 43 of the mobile base 42 so as to drive movement in a forward-rearward direction. The primary hub 44a of the other two of the four wheels 44 (e.g., the rear-left wheel and the front-right wheel) is mounted for rotation with respect to the body 43 of the mobile base 42 so as to drive movement in a lateral direction (i.e., perpendicular to the forward-rearward direction). In some embodiments, the one or more drive motors 46 may include multiple motors. For instance, in one embodiment, each respective wheel 44 may be operably connected to a separate drive motor 46. Each drive motor 46 of the mobile base 42 is operably connected to a controller 110 of the vision and control subsystem 100, such that the controller 110 can selectively communicate instructions (signals) to selectively activate each drive motor 46 to move the mobile base 42.

FIG. 8 is a schematic diagram of an alternative mobile base 342 which may be used within the mobile robot assembly 40 in place of the mobile base 42 described herein with reference to FIG. 2.

Referring now to FIG. 8, in this embodiment, the mobile base 342 is identical to the mobile base 42 described herein with reference to FIG. 2, except that the mobile base 342 includes four mecanum wheels 344 mounted for rotation with respect to the body 43 of the mobile base 342. Throughout the present disclosure, like components are provided with like reference numerals. In this exemplary embodiment, each wheel 344 includes a plurality of rollers 344b integrated into, and mounted for rotation with respect to, a primary hub 344a of the wheel at a 45° angle.

Referring now again to FIG. 2, in this exemplary embodiment, to aid the mobile robot assembly 40 in initially navigating to, and subsequently within, the cargo area 22, the mobile base 42 also includes one or more sensors 48 (FIG. 3) configured to obtain readings regarding the presence of objects around the mobile base 42 that are within the field of view of the one or more sensors 48. In this regard, the one or more sensors 48 may include one or more stereovision cameras and/or light detection and ranging (LIDAR) sensors provided onboard the mobile base 42. For instance, in one embodiment, the one more sensors 48 may comprise multiple sensors of a LIDAR detection system, such as that described in connection with the transport of a parcel cart in co-pending and commonly assigned U.S. Patent Application Publication No. 2020/0276998, which is incorporated herein by reference. Each sensor 48 of the mobile base 42 is operably connected to a controller 110 of the vision and control subsystem 100 such, that readings obtained by the sensor 48 are subsequently transmitted to the vision and control subsystem 100 for further processing, as further described below. Each sensor 48 may be selectively activated to obtain readings in response to instructions (or signals) communicated from the controller 110 of the vision and control subsystem 100 or obtain readings substantially continuously.

Referring now again to FIGS. 1A, 1B, and 2, the framework 55 is mounted on top of the body 43 of the mobile base 42, such that, as the mobile base 42 is moved, the framework 55 is also moved. As the first robot 60 and the second robot 80 are each mounted to, and thus carried by the framework 55, the first robot 60 and the second robot 80 can be moved into close proximity to parcels located in the cargo area 22 (i.e., to a position in which parcels are in reach of the first robot 60 and/or the second robot 80) by repositioning the mobile base 42. As shown best in FIG. 2, the framework 55 defines a central opening 58 through which the transfer conveyor 50 extends. Specifically, in this exemplary embodiment, the conveying surface of the transfer conveyor 50 is positioned above, and is of a length greater than, the mobile base 42, such that the transfer conveyor 50 extends past a front portion of the mobile base 42 to limit the distance which the first robot 60 and the second robot 80 must travel before being able to deposit a parcel onto the transfer conveyor 50.

Referring still to FIGS. 1A, 1B, and 2, in this exemplary embodiment, the transfer conveyor 50 is actually comprised of two separate conveyors: a first conveyor 52 configured to receive parcels transferred by the first robot 60 and the second robot 80; and a second conveyor 54 that is positioned downstream of the first conveyor 52 and offloads parcels onto the distal end 12b of the extendible conveyor 12. As noted above, in this exemplary embodiment, the transfer conveyor 50 is mounted to the mobile base 42 and/or the framework 55 so that as the mobile base 42, both the first conveyor 52 and the second conveyor 54 are also moved. Further, in this exemplary embodiment, the transfer conveyor 50 is operably connected to the controller 110 of the vision and control subsystem 100 (FIG. 3), such that the first conveyor 52 and the second conveyor 54 can be independently and selectively driven in response to instructions (signals) communicated from the controller 110. Alternative embodiments are, however, contemplated in which the transfer conveyor 50 operates independently of the vision and control subsystem 100 and/or is continuously driven while the system 10 is in use.

Although the first conveyor 52 is illustrated in the drawings as being oriented as to extend upwardly to the second conveyor 54 in a ramp-like configuration, the first conveyor 52 is not necessarily limited to such orientation. Rather, embodiments are also contemplated in which the first conveyor 52 can be repositioned (e.g., in response to instructions (signals) communicated from the controller 110) relative to the second conveyor 54 to further reduce the distance which the first robot 60 and the second robot 80 must travel before being able to deposit a parcel onto the transfer conveyor 50. For instance, in one alternative embodiment, the first conveyor 52 may be configured to transition between: a variety of orientations in which the first conveyor 52 is angled as to extend upwardly to the second conveyor 54 (FIGS. 1A, 1B, and 2) for parcels at a low-level height (i.e., below the plane along which the second conveyor 54 is positioned) within the cargo area 22; a variety of orientations in which the first conveyor 52 is angled as to extend downwardly toward the second conveyor (not shown) for parcels at a high-level height (i.e., above the plane along which the second conveyor 54 is positioned) within the cargo area 22, and an orientation in which the first conveyor 52 and the second conveyor 54 are substantially linearly arranged (not shown) for parcels at a mid-level height (i.e., positioned at substantially the same height as the second conveyor 54) within the cargo area 22. In such embodiments, the mobile robot assembly 40 may include one or more linear actuators pivotally connected to the first conveyor 52 and at least one of the mobile base 42 and the framework 55, such that the linear actuators can be selectively activated (e.g., in response to instructions communicated by the vision and control subsystem 100) to raise or lower the first conveyor 52.

It should also be appreciated that while the first conveyor 52 and the second conveyor 54 are each illustrated in the drawings as being defined by a single belt conveyor, embodiments are also contemplated in which the first conveyor 52 and/or the second conveyor 54 are defined by multiple conveyors. For instance, in some alternative embodiments, the second conveyor 54 may be comprised of two belt conveyors which are positioned beside each other (i.e., in parallel), and which can be independently driven (e.g., in response to instructions communicated by the vision and control subsystem 100) to prevent a buildup of parcels on the second conveyor 54 when parcels are transferred by the first robot 60 and the second robot 80 either simultaneously or in quick succession.

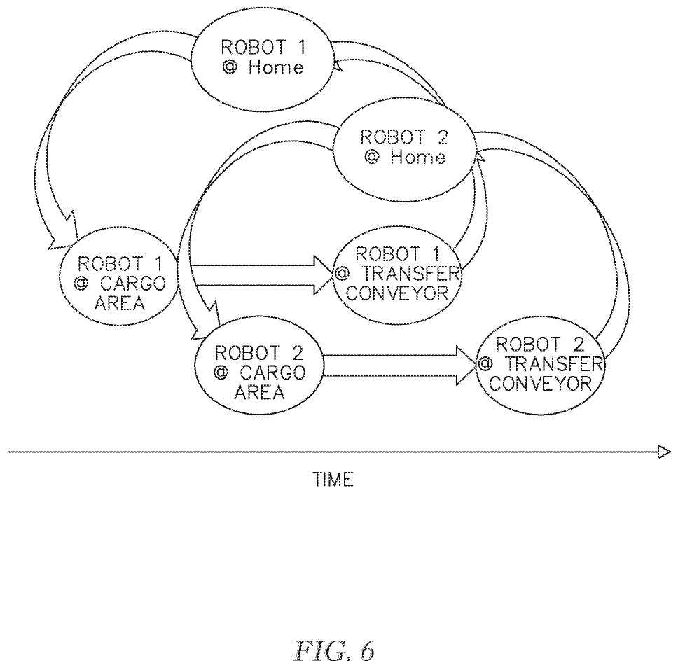

FIG. 6 is a diagram illustrating movement cycles performed by the first robot 60 and the second robot 80 to transfer parcels from the cargo area 22 to the transfer conveyor 50.

Referring now to FIGS. 1A, 1B, 2, and 6, in this exemplary embodiment, the first robot 60 is defined by, and thus may be characterized as including, a first robotic arm 62 and a first end effector 70 mounted to a distal end of the first robotic arm 62. Similarly, in this exemplary embodiment, the second robot 80 is defined by, and thus may be characterized as including, a second robotic arm 82 and a second end effector 90 mounted to a distal end of the second robotic arm 82. More specifically, in this exemplary embodiment, the first robotic arm 62 and the second robotic arm 82 are each a six-axis articulating robotic arm, and the first end effector 70 and the second end effector 90 are each a vacuum-based end effector. One suitable robot which can be used as the first robotic arm 62 and the second robotic arm 82 is the M-20iD/35 robot manufactured by and available from FANUC America of Rochester Hills, Mich. As shown in FIG. 6, in transferring parcels from the cargo area 22 to the transfer conveyor 50, the first robot 60 and the second robot 80 each follow the same general movement cycle, which, in this case, includes three movements: a first movement from a predetermined initial (or “home”) position to a target parcel within the cargo area to initiate transfer of a target parcel; a second movement from the point of engagement with the target parcel to a position above a section of the transfer conveyor 50 (which, in this case, is the first conveyor 52) to deliver the target parcel; and a third movement from the position above the transfer conveyor 50 back to the home position. In this exemplary embodiment, when in the “home” position, the first robot 60 and the second robot 80 are in the orientation show in FIG. 1B.

Referring now specifically to FIG. 2, in this exemplary embodiment, the first end effector 70 includes an array of vacuum cups 72. In some embodiments, the entire array of vacuum cups 72 can be activated (or deactivated) simultaneously, while in other embodiments, each respective vacuum cup 72 can be independently activated (or deactivated). Similarly, the second end effector 90 also includes an array of vacuum cups 92. Again, in some embodiments, the entire array of vacuum cups 92 can be activated (or deactivated) simultaneously, while in other embodiments, each respective vacuum cup 92 can be independently activated (or deactivated). In this regard, each respective vacuum cup 72 of the first end effector 70 and each respective vacuum cup 92 of the second end effector 90 can be selectively placed in fluid communication with a vacuum source (not shown) to provide the respective vacuum cup 72, 92 with a suction force that can be used to maintain a parcel in engagement with the first end effector 70 or the second end effector 90 while being transferred to the transfer conveyor 50.

Referring still to FIG. 2, in embodiments in which the vacuum cups 72, 92 of the first end effector 70 and the second end effector 90 are independently activated, to manage which vacuum cups 72, 92 are placed in fluid communication with the vacuum source, the system 10 further includes a vacuum control subsystem 75 (FIG. 3) that is operably connected to the controller 110 of the vision and control subsystem 100. The vacuum control subsystem 75 is configured to selectively place the vacuum cups 72 of the first end effector 70 in fluid communication with the vacuum source as well as to selectively place the vacuum cups 92 of the second end effector 90 in fluid communication with the vacuum source based on instructions communicated by the controller 110 of the vision and control subsystem 100. Suitable vacuum cups which may be utilized in the first end effector 70 and the second end effector 90 include those described in commonly assigned: U.S. Patent Application Publication No. 2020/0262069; U.S. Patent Application Publication No. 2021/0221002; and U.S. Pat. No. 11,241,802, each of which is incorporated herein by reference.

Referring still to FIG. 2, to increase the range of motion of the first robot 60 and the second robot 80 in a manner which better enables the first robot 60 and the second robot 80 to engage and transfer parcels located at different heights within the cargo area 22, the first robotic arm 62 and the second robotic arm 82 are each mounted for vertical movement with respect to the framework 55. To this end, in this exemplary embodiment, the framework 55 includes a first guide rail 57 to which a base of the first robotic arm 62 is mounted, such that the base of the first robotic arm 62 can move along the first guide rail 57 to adjust the vertical position of the first robot 60. Similarly, the framework 55 includes a second guide rail 59, which, in this case, is mounted on the opposite side of the central opening 58 as the first guide rail 57, to which a base of the second robotic arm 82 is mounted, such that the base of the second robotic arm 82 can move along the second guide rail 59 to adjust the vertical position of the second robot 80. In this exemplary embodiment, the first guide rail 57 and the second guide rail 59 are each defined by a pair of vertically oriented shafts.

Referring still to FIG. 2, to regulate movement of the base of the first robotic arm 62 along the length of the first guide rail 57 and the base of the second robotic arm 82 along the length of the second guide rail 59, in this exemplary embodiment, the mobile robot assembly 40 further includes a first actuator 51 and a second actuator 53. The first actuator 51 is mounted to the framework 55 and is operably connected to the first robotic arm 62, such that the first actuator 51 can be selectively activated to raise or lower the first robot 60. The second actuator 53 is mounted to the framework 55 and is operably connected to the second robotic arm 82, such that the second actuator 53 can be selectively activated to raise or lower the second robot 80. The first actuator 51 and the second actuator 53 are each operably connected to the controller 110 of the vision and control subsystem 100, such that the controller 110 can selectively communicate instructions (signals) to each of the first actuator 51 and the second actuator 53 to reposition the first robot 60 and the second robot 80, respectively, along the framework 55 (e.g., based on image data processed by the vision and control subsystem 100). In this exemplary embodiment, the first actuator 51 and the second actuator 53 are each a linear actuator. However, it is appreciated that other means for effectuating movement of the first robot 60 and the second robot 80 along the length of the first guide rail 57 and the second guide rail 59, respectively, may alternatively be used without departing from the spirit and scope of the present invention.

FIG. 3 is a schematic diagram of the vision and control subsystem 100.

Referring now to FIGS. 2 and 3, the vision and control subsystem 100 generally includes the controller 110 and a vision unit 120. The vision unit 120 is operably connected to the controller 110, such that the controller 110 can communicate instructions to, and receive image data from, the vision unit 120. The vision unit 120 includes one or more cameras. In this exemplary embodiment, and as shown in FIGS. 2 and 3, there are five cameras: a first camera 121 mounted to the framework 55 above the central opening 58; a second camera 123 mounted to a lower left portion of the framework 55; a third camera 125 mounted to a lower right portion of the framework 55; a fourth camera 127 mounted to the first end effector 70; and a fifth camera 129 mounted to the second end effector 90. One of skill in the art will readily appreciate that, in alternative embodiments and implementations, the number of cameras and/or positioning of the cameras of the vision unit 120 may vary to better accommodate different unloading applications or environments without departing from the spirit and scope of the present invention.

Referring still to FIGS. 2 and 3, the first camera 121, the second camera 123, the third camera 125, the fourth camera 127, and the fifth camera 129 are each configured to obtain two-dimensional and/or three-dimensional images of parcels within the cargo area 22. Suitable cameras for use in the vision unit 120 include three-dimensional image sensors manufactured and distributed by ifm Effector Inc. of Malvern, Pa.

Referring now specifically to FIG. 3, in this exemplary embodiment, images captured by the first camera 121, the second camera 123, the third camera, 125, the fourth camera, 127, and the fifth camera 129 are processed locally by the vision unit 120. To this end, the vision unit 120 includes a processor 122 configured to execute instructions (routines) stored in a memory component 124 or other computer-readable medium to process images captured by the first camera 121, the second camera 123, the third camera, 125, the fourth camera, 127, and the fifth camera 129. Each camera 121, 123, 125, 127, 129 may be selectively activated to obtain images in response to instructions (signals) communicated from the processor 122 (e.g., as a result of instructions communicated from the controller 110) or obtain images substantially continuously. The images processed by the processor 122 of the vision unit 120 are output as image data, which is transmitted to the controller 110 for subsequent processing to affect operation of the first actuator 51, the second actuator 53, the first robot 60, and/or the second robot 80, as further described below. Accordingly, the processor 122 of the vision unit 120 may also be characterized as an image pre-processor. Although the processor 122 is illustrated as comprising only a single processor, it is appreciated that the vision unit 120 can comprise multiple processors. For instance, in some embodiments, each respective camera of the vision unit 120 may have a processor associated therewith to process the images obtained by the camera. One suitable processor which may be utilized in the vision unit 120 is that provided within the Jetson Nano computer manufactured and distributed by Nvidia Corporation of Santa Clara, Calif., although other processors suitable of performing the operations of the processor 122 of the vision unit 120 described herein may alternatively be used.

Referring still to FIG. 3, the controller 110 includes a processor 112 configured to execute instructions stored in a memory component 114 or other computer-readable medium to perform the various operations described herein for the controller 110. In this exemplary embodiment, the controller 110 is a programmable logic controller or other industrial controller. The controller 110 is operably connected to the processor 122 of the vision unit 120 to facilitate the transmission of image data from the vision unit 120 to the controller 110 and the communication of instructions from the controller 110 to the vision unit 120, either by wired connection (e.g., Ethernet connection) or by wireless connection (e.g., via a network) using known interfaces and protocols. The processor 112 of the controller 110 and the processor 122 of the vision unit 120 may be housed within the body 43 of the mobile base 42.

Although it is generally preferred that the controller 110 and the vision unit 120 are each provided with their own processors 112, 122, in alternative embodiments, a single processor may be used to carry out the respective operations described herein for the processor 112 of the controller 110 and the processor 122 of the vision unit 120. In this regard, in some embodiments, the vision unit 120 may be a component of the controller 110 or be characterized as including only the first camera 121, the second camera 123, the third camera 125, the fourth camera 127, and the fifth camera 129. Accordingly, alternative embodiments are contemplated in which the images obtained by the cameras 121, 123, 125, 127, 129 are processed by the processor 112 of the controller 110. In such embodiments, the image data received by the controller 110 for subsequent processing would be in the form of unprocessed images from the cameras 121, 123, 125, 127, 129.

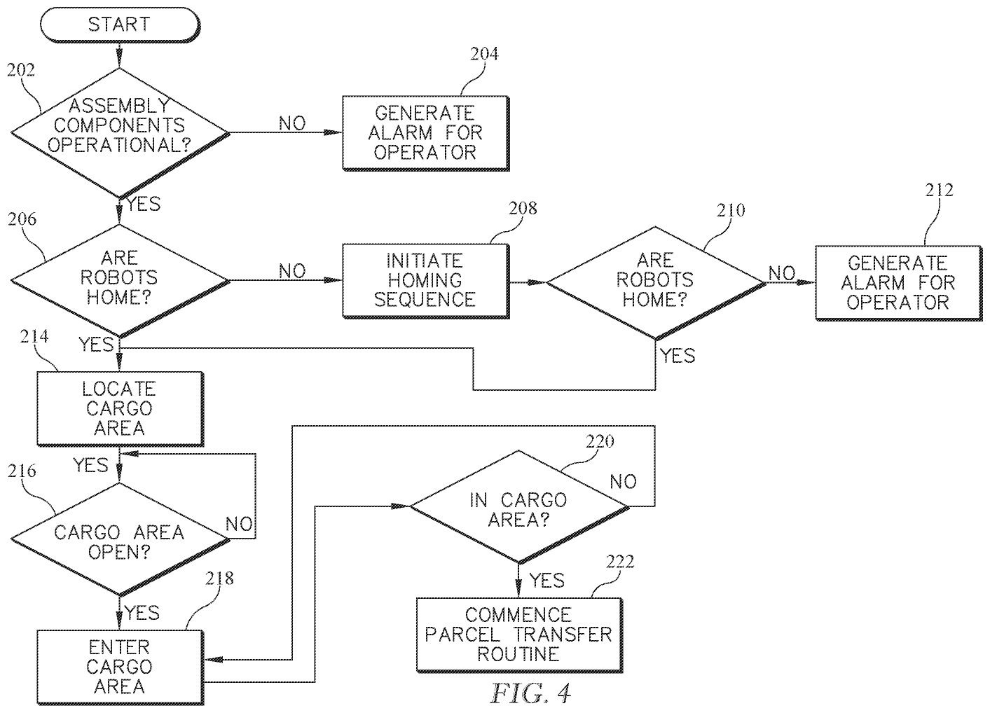

FIG. 4 is a flow chart illustrating an exemplary routine for initializing the mobile robot assembly 40 to unload the cargo area 22.

It should be appreciated that the routines and subroutines described herein correspond to a set of instructions that are stored in the memory component 114 and can be executed by the processor 112 of the controller 110, unless otherwise specified.

It should also be appreciated that, in instances where the controller 110 is referred to as performing an operation in which one or more objects is identified and/or in which a determination is made that, in some embodiments and implementations, such identification and determination operations may be facilitated by the processor 112 of the controller 110 executing instructions corresponding to a machine learning algorithm, artificial intelligence classifier, or other image recognition or classification program stored in the memory component 114 and configured to assign a class or other identification label to a data input.

Referring now to FIGS. 3 and 4, to ensure the respective components of the mobile robot assembly 40 are operational and positioned to facilitate the various operations described herein, in this exemplary implementation, an initiation routine is first executed by the vision and control subsystem 100 prior to the mobile robot assembly 40 entering into the cargo area 22. Specifically, as indicated by decision 202 in FIG. 4, the initiation routine commences with the vision and control subsystem 100 determining whether the vacuum control subsystem 75 and each respective component of both the mobile robot assembly 40 and the vision unit 120 are operational. In this regard, the processor 112 of the controller 110 may execute instructions which cause the controller 110 to determine whether the foregoing components are activated (e.g., as indicated by whether the controller 110 is receiving feedback (or signals) from the respective components generally and/or image data received from the vision unit 120) and/or satisfy one or more predetermined criteria (e.g., as indicated by the nature of the feedback (or signals) received from such components and/or image data from the vision unit 120). In the event a component checked by the vision and control subsystem 100 is determined to be nonoperational, in this exemplary implementation, the controller 110 will generate an alarm to notify an operator of such component's dysfunction, as indicated by block 204 in FIG. 4. In some cases, the alarm generated by the controller 110 may be in the form of a visual cue displayed on a display (not shown) that is operably connected to the controller 110 and/or an audible cue projected from a speaker (not shown) that is operably connected to the controller 110.

Referring now to FIGS. 3, 4, and 6, after the first robot 60 and the second robot 80 are determined to be operational, the vision and control subsystem 100 assesses whether the first robot 60 and the second robot 80 are each in the home position, as indicated by decision 206 in FIG. 4. For each robot determined not to be in the home position, the controller 110 will communicate instructions (or signals) which cause that robot and/or the actuator 51, 53 associated therewith to perform a homing sequence which returns the robot to its home position, as indicated by block 208 in FIG. 4. Once the homing sequence for each robot initially determined not to be in the home position is completed, the vision and control subsystem 100 then reassesses the positioning of the first robot 60 and the second robot 80 to determine if both are in the home position, as indicated by decision 210 in FIG. 4. In this regard, and in some implementations, the controller 110 may process information (e.g., coordinate data) received from the first robot 60 and the second robot 80 and/or image data received from the vision unit 120 to determine the positioning of the first robot 60 and the second robot 80. In this implementation, if, after completion of the homing sequence, either robot is again determined not to be in the home position, the controller 110 will generate an alarm to notify an operator that the first robot 60 and/or the second robot 80 are not correctly positioned, as indicated by block 212 in FIG. 4.

Referring now to FIGS. 1A, 1B, 3, 4, and 6, once the first robot 60 and the second robot 80 are both determined to be in the home position, the controller 110 communicates instructions (or signals) which cause the mobile robot assembly 40 to locate the cargo area 22, as indicated by block 214 in FIG. 4. As, in this particular implementation, the cargo area 22 corresponds to the interior of a trailer portion 20 of a tractor trailer, the controller 110 communicates instructions which cause the mobile robot assembly 40 to move to the loading bay 30 where the trailer portion 20 is docked. In this regard, if the mobile robot assembly 40 is docked or otherwise is positioned in an area from which the pathway to the loading bay 30 is known, the controller 110 may communicate instructions (signals) which selectively activate the one or more drive motors 46 in a manner which drives the mobile base 42 along such pathway to the loading bay 30. In this exemplary embodiment, the controller 110 communicates instructions directly to the one or more drive motors 46. Alternative embodiments are, however, contemplated in which the mobile base 42 further includes an onboard control subsystem that is configured to: receive instructions communicated from the controller 110; analyze the same; and communicate instructions (signals) to the one or more drive motors 46, such as the SDV control subsystem disclosed in U.S. Patent Application Publication No. 2021/0206582, which is incorporated herein by reference. In such embodiments, the onboard control subsystem may process the readings from the one or more sensors 48 prior to such readings being transmitted to the controller 110. As the mobile robot assembly 40 is in transit, readings are obtained by the one or more sensors 48 of the mobile base 42 and communicated to the controller 110 for processing. Based on the nature of the readings received, the controller 110 may communicate instructions to the one or more drive motors 46 to direct the mobile robot assembly 40 away from the known pathway (e.g., to avoid obstacles). In some embodiments, image data from the vision unit 120 may also be received and processed by the controller 110 to determine whether the mobile robot assembly 40 should diverge from a known pathway to avoid a collision or otherwise. In some implementations, the instructions communicated from the controller 110 to the one or more drive motors 46 of the mobile base 42 may be based primarily or exclusively upon readings from the one or more sensors 48 of the mobile base 42 and/or image data from the vision unit 120. Additionally, the mobile base 42 can further include a GPS tracking chip operably connected to the controller 110, such as that in U.S. Patent Application Publication No. 2021/0206582, that provides data regarding the physical location of the mobile robot assembly 40 to the controller 110. In such implementations, the instructions communicated from the controller 110 to affect movement of the mobile robot assembly 40 may be based, at least in part, on the readings obtained from the GPS tracking chip.

Referring now to FIGS. 1A, 1B, 3, and 4, upon reaching the loading bay 30, the vision and control subsystem 100 determines whether the cargo area 22 is accessible to the mobile robot assembly 40, as indicated by decision 216 in FIG. 4. In this regard, once the mobile robot assembly 40 is positioned at the loading bay 30, the controller 110 receives and processes readings from the one or more sensors 48 of the mobile base 42 and/or image data from the vision unit 120 to determine whether: (i) a door associated with the loading bay 30, if any, is in a closed configuration, thus preventing access to the cargo area 22; (ii) the cargo area 22 is not positioned at the loading bay 30 (e.g., based on the presence or absence of the trailer portion 20 of the tractor trailer at the loading bay 30 and/or proximity of the trailer portion 20 to the loading bay 30); and (iii) a door associated with the cargo area 22 (e.g., a door of the trailer portion 20 of the tractor trailer), if any, is in a closed configuration, thus preventing access to the cargo area 22. If each of the above conditions are determined to be false, the controller 110 will communicate instructions which cause the one or more drive motors 46 to drive the mobile robot assembly 40 into the cargo area 22. Conversely, in this implementation, if any one of the above conditions are determined to be true, the vision and control subsystem 100 will wait a predetermined period of time and then reassess whether the cargo area 22 is accessible to the mobile robot assembly 40. Of course, the controller 110 can be alternatively programmed to better accommodate different unloading applications or working environments. For instance, in some implementations, if any one of the above conditions are determined to be true, the controller 110 may generate a visual and/or audible alarm to alert an operator that the cargo area 22 cannot be accessed.

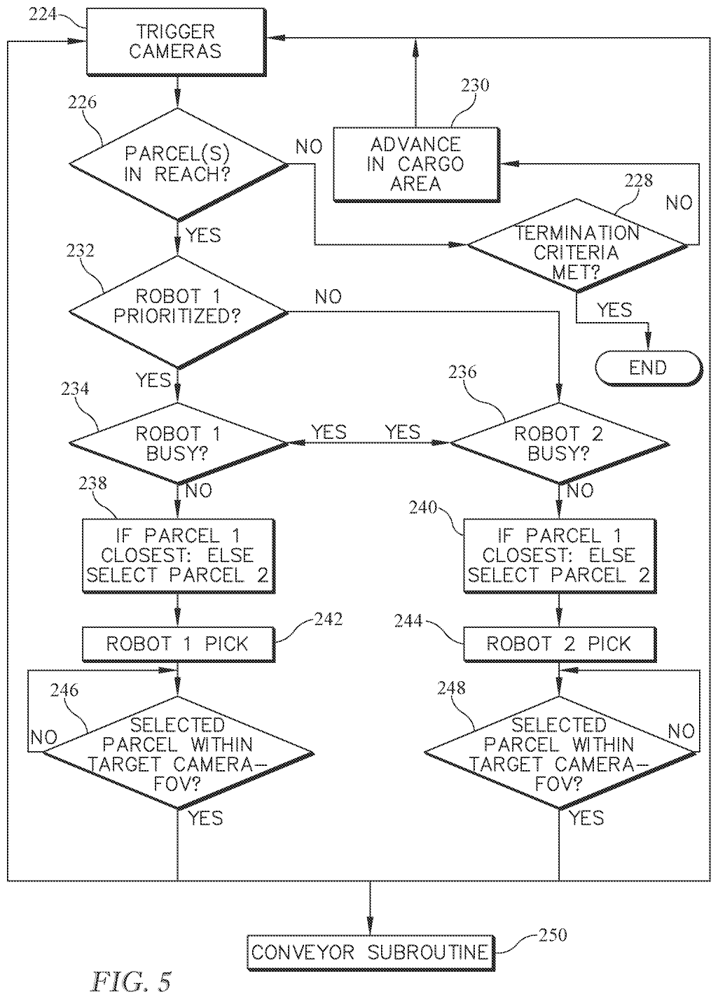

Referring still to FIGS. 1A, 1B, 3, and 4, as noted above, once it is determined that the cargo area 22 is accessible to the mobile robot assembly 40, the controller 110 will communicate instructions which cause the one or more drive motors 46 to move the mobile robot assembly 40 into the cargo area 22, as indicated by block 218 in FIG. 4. As the mobile robot assembly 40 enters the cargo area 22, readings from the one or more sensors 48 and/or image data from the vision unit 120 is processed by the controller 110 to determine whether the mobile robot assembly 40 is fully positioned within the cargo area 22, as indicated by decision 220 in FIG. 4. Upon receiving readings and/or image data indicative of the mobile robot assembly 40 being fully positioned within the cargo area 22, the controller 110 will determine it is appropriate to proceed with unloading parcels from the cargo area 22, as indicated by block 222 in FIG. 4 and as further described below with reference to FIG. 5.

FIG. 5 is a flow chart illustrating an exemplary parcel transfer routine which can be employed by the mobile robot assembly 40 to unload the cargo area 22.

Referring now to FIGS. 1A, 1B, 3, and 5, in this exemplary implementation, to commence unloading parcels from the cargo area 22, the cameras 121, 123, 125, 127, 129 of the vision unit 120 are activated to obtain images of the cargo area 22 within the field of view of the cameras 121, 123, 125, 127, 129 and any parcels located therein, as indicated by block 224 in FIG. 5. In this exemplary implementation, the images are then processed by the processor 122 of the vision unit 120. The vision unit 120 then transmits image data corresponding to the images obtained by the cameras 121, 123, 125, 127, 129 to the controller 110 for further processing. Based on the image data received from the vision unit 120, the controller 110 determines whether any parcels are located with a predetermined distance (i.e., with reach) of the first robot 60 or second robot 80, as indicated by decision 226 in FIG. 5. In this exemplary implementation, if no parcels are detected as being in reach of the first robot 60 or the second robot 80, the controller 110 communicates instructions which cause the one or more drive motors 46 of the mobile base 42 to advance the mobile robot assembly 40 further into the cargo area 22, as indicated by block 230 in FIG. 5. After the mobile robot assembly 40 has advanced a predetermined distance, the operations described above with reference to block 224 and decision 226 are repeated to reassess whether there are any parcels within the cargo area 22 within reach of the first robot 60 or the second robot 80. As the mobile robot assembly 40 advances further into the cargo area 22 (i.e., farther away from the loading bay), the telescoping sections 14, 15, 16, 17, 18 of the extendible conveyor 12 are gradually extended so that the distal end 12b of the extendible conveyor 12 remains in close proximity to an offloading end of the transfer conveyor 50. In this exemplary implementation, the operations of the extendible conveyor 12 (i.e., extending between the retracted and extended configuration and driving of the conveying surface the respective telescoping sections 14, 15, 16, 17, 18) are achieved via user engagement with a control panel (not shown) provided on the extendible conveyor 12. Alternatively, the operations of the extendible conveyor 12 may also be controlled by the controller 110, as further described below.

Referring still to FIGS. 1A, 1B, 3, and 5, in this exemplary implementation, prior to communicating instructions to advance the mobile robot assembly 40 further into the cargo area 22, the controller 110 will determine whether a termination condition (or criteria) has been satisfied and that unloading of the cargo area 22 should be ceased, as indicated by decision 228 in FIG. 5. In this implementation, the termination condition is a condition which is indicative of the cargo area 22 being free of any remaining parcels in need of unloading. Accordingly, the mobile robot assembly 40 will continue to advance within the cargo area 22 until either one or more parcels are detected within the cargo area 22 and determined to be in reach of the first robot 60 or the second robot 80 or the termination condition is satisfied, at which time the parcel transfer routine is ended. The termination condition is meant to prevent the mobile robot assembly 40 from continuously advancing, or at least attempting to continuously advance, within the cargo area 22 despite the cargo area 22 being fully unloaded. In some embodiments and implementations, the termination condition may correspond to a count value reaching a predetermined value. The count value can be indicative of the number of times in which the mobile robot assembly 40 has previously been advanced within the cargo area 22 without one or more parcels within the cargo area 22 being determined to be in reach of the first robot 60 or the second robot 80 (i.e., the number of times the operations associated with blocks 224, 230 and decisions 226, 228 in FIG. 5 have been carried out in a row) reaching a predetermined value. In some embodiments and implementations, such predetermined value may correspond to the number of times in which the mobile robot assembly 40 can typically be advanced a predetermined distance prior to reaching the end of a standard sized trailer portion 20 of a tractor trailer. Of course, the termination condition can be alternatively defined to better accommodate different unloading applications or environments without departing from the spirit or scope of the present invention. For instance, in some embodiments and implementations, the termination condition may correspond to the controller 110 receiving image data from the vision unit 120 indicating that a back wall of the trailer portion 20 is visible without obstruction, thus signifying no parcels are located in the cargo area 22.

Referring now to FIGS. 1A, 3, and 5, once the vision and control subsystem 100 determines one or more parcels in the cargo area 22 are in reach of the first robot 60 or the second robot 80, the controller 110 communicates instructions which cause the first robot 60 and the second robot 80 to engage and transfer those parcels within reach to the transfer conveyor 50. In the steps that follow regarding the exemplary parcel transfer routine illustrated in FIG. 5, the first robot 60 and the second robot 80 are described in the context of transferring parcels to the transfer conveyor 50 successively. It should be appreciated, however, that the first robot 60 and the second robot 80 are not limited to transferring parcels in this manner. In this regard, it is understood that in addition to transferring parcels in succession, the first robot 60 and the second robot 80 can also transfer separate parcels simultaneously to the transfer conveyor 50 as well as work in conjunction to transfer a single parcel to the transfer conveyor 50. For instance, in cases where two parcels are identified by the vision and control subsystem 100 as being below a predetermined size or dimension within the reach of the first robot 60 and the second robot 80 (e.g., smaller parcels, such as flexible plastic (“poly”) bags or flat envelopes), unloading efficiency may be improved by virtue of the first robot 60 and the second robot 80 each transferring one of the two parcels to the transfer conveyor 50 in unison. In such case, the controller 110 will communicate instructions which cause the first robot 60 and the second robot 80 to simultaneously transfer the two parcels to the transfer conveyor 50. In other cases, where a single parcel is identified by the vision and control subsystem 100 as being above a predetermined size or dimension or as likely being a heavy object, the controller 110 may communicate instructions which cause the first robot 60 and the second robot 80 to work together to transfer such parcel to the transfer conveyor 50, as shown in FIG. 1A. Accordingly, in some implementations, the controller 110 may determine (e.g., subsequent to determining one or more parcels are in reach of the first robot 60 and/or the second robot 80 in decision 226 in FIG. 5) the type of parcels and/or material of the parcels within the reach of the first robot 60 and/or the second robot 80 based on the image data received from the vision unit 120. In such implementations, the results of the foregoing determination will typically determine whether the controller 110 subsequently communicates instructions which cause the first robot 60 and the second robot 80 to either engage and transfer parcels independently or in unison.

Referring now again to FIGS. 1A, 1B, 3, and 5, to reduce downtime associated with parcel transfer from the cargo area 22 to the transfer conveyor 50 and thus improve parcel throughput rate, in this exemplary implementation, the controller 110 selectively communicates parcel transfer instructions to the first robot 60 and the second robot 80 by following a selection subroutine, as indicated by decisions 232, 234, 236 and blocks 238, 240 in FIG. 5. When executed, the selection subroutine causes the controller 110 to determine which robot of the first robot 60 and the second robot 80 should be selected for parcel transfer and which parcel within the cargo area 22 should be transferred at a given time in instances where multiple parcels are located in the cargo area 22 and within reach of the first robot 60 and the second robot 80. In this exemplary implementation, the selections resulting from execution of the selection subroutine are based on a priority queue, the availability of each robot, and/or the proximity of the parcels to a selected robot, as further described below.

Referring still to FIGS. 1A, 1B, 3, and 5, in this exemplary implementation, the selection subroutine commences with the controller 110 determining whether the first robot 60 or the second robot 80 has priority to engage and transfer a parcel from the cargo area 22, as indicated by decision 232 in FIG. 5. In this exemplary implementation, whether the first robot 60 or the second robot 80 has priority to engage and transfer a parcel at a given time is dictated by a priority queue, which, at a given time, contains one or more entries corresponding to the order in which the first robot 60 and/or the second robot 80 will be given initial priority to engage and transfer parcels from the cargo area 22. To reduce processing times, in this exemplary implementation, at least the initial entry of the priority queue is predetermined and corresponds to which robot will be the first to engage and transfer a parcel within the cargo area 22. Subsequent entries of the priority queue may be predetermined or populated and assigned by the controller 110 during the parcel transfer process.

Referring still to FIGS. 1A, 1B, 3, and 5, once priority is determined, the controller 110 subsequently determines whether the robot with priority is actually available to transfer a parcel to the transfer conveyor 50, as indicated by decisions 234, 236 in FIG. 5. If the robot with priority is available, the controller 110 will select that robot to effectuate transfer of a parcel from the cargo area 22 to the transfer conveyor 50. However, in the event the robot with priority is busy or otherwise unavailable to transfer a parcel to the transfer conveyor 50, the controller 110 will assess whether the robot without priority is available to transfer the parcel and instead select that robot to effectuate transfer of the parcel, provided the robot without priority is not also busy or otherwise unavailable in which case decisions 234 and 236 will be repeated in succession until one robot is determined to be available. For instance, if the first robot 60 has priority, but is returning from transferring a first parcel to the transfer conveyor 50, and the second robot 80 is in the home position, then the controller 110 will select the second robot 80 to effectuate transfer of a selected second parcel in the cargo area 22 to the transfer conveyor 50. By determining and selecting the first available robot to effectuate transfer of a parcel, the robot selection subroutine thus effectively reduces or eliminates instances in which a selected parcel is delayed transfer due to the unavailability of a robot singulator, and, in this way, reduces or eliminates downtime associated with transferring parcels from the cargo area 22 to the transfer conveyor 50.

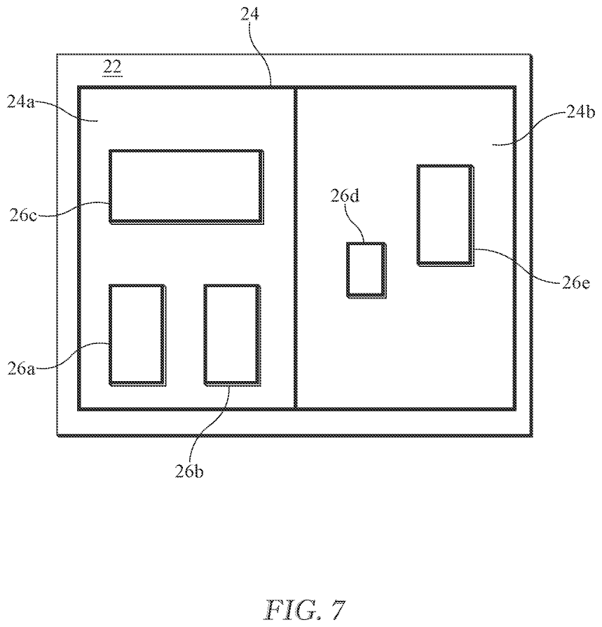

FIG. 7 is a top view of a portion of the cargo area 22 nearest to the mobile robot assembly 40 in FIG. 1A.

Referring now to FIGS. 1A, 1B, 3, 5, and 7, after the first robot 60 or the second robot 80 is selected by the controller 110, the controller 110 determines which parcel in the cargo area 22 and in reach of the first robot 60 and the second robot 80 will be transferred to the transfer conveyor 50 by the selected robot. In instances where the image data received from the vision unit 120 indicates that only a single parcel is located within the cargo area 22 and in reach of the first robot 60 and the second robot 80, the controller 110 will communicate instructions to the selected robot to engage and transfer that parcel to the transfer conveyor 50. However, in instances where the image data received by the controller 110 from the vision unit 120 indicates multiple parcels are located within the cargo area 22 and in reach of the first robot 60 and the second robot 80 (e.g., as shown in FIG. 1A), the controller 110 will, in this exemplary implementation, select one of the parcels to be transferred to the transfer conveyor 50 based on parcel proximity to the selected robot. Specifically, in this exemplary implementation, the controller 110 is configured to select the parcel closest to the selected robot for transfer, as indicated by blocks 238, 240 in FIG. 5. In this exemplary implementation, the location data associated with each respective parcel corresponds to the coordinates (e.g., x-coordinate values and y-coordinate values) of a portion 24 of the cargo area 22 reflected in one or more images obtained by the cameras 121, 123, 125, 127, 129 of the vision unit 120, as perhaps best evidenced in FIG. 7. In some implementations, the location data may further include an indication as to whether each respective parcel is located within a first area 24a or a second area 24b of the portion 24 of the cargo area 22 reflected in one or more images obtained by the cameras 121, 123, 125, 127, 129 of the vision unit 120. In such implementations, the controller 110 may thus determine which parcel is closest to the selected robot based on coordinates of each respective parcel within the portion 24 of the cargo area 22 reflected in one or more images obtained by the cameras 121, 123, 125, 127, 129 of the vision unit 120, which area 24a, 24b of the portion 24 of the cargo area 22 reflected in one or more images obtained by the cameras 121, 123, 125, 127, 129 of the vision unit 120 the parcels are located, or a combination thereof.

Referring now to FIGS. 1A, 1B, 2, 3, 5, and 7, the location data of each respective parcel within the portion 24 of the cargo area 22 reflected in one or more images obtained by the cameras 121, 123, 125, 127, 129 of the vision unit 120 may be initially generated by the vision unit 120 while processing the images acquired by the cameras 121, 123, 125, 127, 129 and the image data subsequently transmitted to the controller 110. As shown in FIG. 7, in some implementations, the vision unit 120 may utilize bounding boxes 26a-e when identifying parcels and generating parcel coordinates. The coordinates of the parcel determined to be closest to the selected robot are included in instructions communicated from the controller 110 to the selected robot, which cause the selected robot to engage and transfer the selected parcel to the transfer conveyor 50, as indicated by blocks 242, 244 in FIG. 5. Prior to the communication of such instructions to the selected robot, however, the controller 110 preferably processes the coordinates of the parcel determined to be closest to the selected robot to determine whether vertically repositioning the selected robot along the framework 55 would enable the selected robot to more efficiently transfer the selected parcel to the transfer conveyor 50. In instances where it is determined that vertically repositioning the selected robot would improve parcel transfer efficiency, the controller 110 will communicate instructions to the actuator 51, 53 associated with the selected robot to reposition the selected robot to a particular position along the guide rail 57, 59 to which the selected robot is mounted.

Of course, in alternative implementations of the selection subroutine, the controller 110 may first select a parcel reflected within the image data for transfer and then determine which robot should be selected to facilitate the transfer of such parcel based on the location of the parcel within the cargo area 22 and proximity to the first robot 60 and the second robot 80. In such implementations, the selections resulting from execution of the selection subroutine may thus be based on the proximity of the parcels to the first robot 60 and the second robot 80 and/or availability of the first robot 60 and the second robot 80.

Referring now to FIGS. 1A, 1B, 2, 3, and 5, once the controller 110 has communicated instructions to the selected robot to engage and transfer the selected parcel, the vision and control subsystem 100 verifies whether the selected parcel was successfully engaged and transferred out of the cargo area 22 and onto the transfer conveyor 50 by the selected robot. To this end, in this exemplary implementation, the controller 110 determines whether the selected parcel is within the field of view of one or more of the cameras 121, 123, 125, 127, 129 of the vision unit 120 having the first conveyor 52 of the transfer conveyor 50 within its field of view, which, in this case, is the first camera 121, as indicated by decisions 246, 248. In this regard, the controller 110 thus communicates instructions which causes the vision unit 120 to assess whether the selected parcel is out of the field of view of the first camera 121 and communicate the results of such assessment to the controller 110. To initiate this process, in some implementations, the controller 110 may communicate instructions which cause the first camera 121 to acquire an additional image of the cargo area 22 subsequent to communicating instructions to the selected robot to engage and transfer the selected parcel. In such implementations, the processor 122 of the vision unit 120 then processes the image and transmits image data to the controller 110 which indicates whether the selected parcel is in the field of view of the first camera 121, thus indicating whether the selected parcel was successfully engaged and transferred to the transfer conveyor 50. If the controller 110 determines that the selected parcel is not within the field of view of the first camera 121, the foregoing process may be repeated after a predetermined period of time to provide the selected robot with additional time to transfer the selected parcel. If the selected parcel is not within the field of view of the first camera 121 after a predetermined period of time or after a predetermined number of iterations of acquiring and processing additional images obtained by the first camera 121, then the controller 110 may communicate instructions to restart the parcel transfer routine (the start of which is indicated by block 224 in FIG. 5). Conversely, if the controller 110 determines that the selected parcel is within the field of view of the first camera 121, in this exemplary implementation, the controller 110 will proceed to initiate a conveyor subroutine to advance parcels loaded on the transfer conveyor 50 toward the extendible conveyor 12, as indicated by block 250 in FIG. 5, as well as communicate instructions to restart the parcel transfer routine to initiate the transfer of additional parcels within the cargo area 22.

Referring still to FIGS. 1A, 1B, 2, 3, and 5, in this exemplary implementation, the conveyor subroutine comprises the first conveyor 52 and the second conveyor 54 being indexed a predetermined distance (i.e., driven at a designated speed for a predetermined period of time) in response to instructions communicated from the controller 110 to advance parcels loaded thereon toward the distal end 12b of the extendible conveyor 12. It is appreciated, however, that the conveyor subroutine may be adapted to better accommodate different unloading applications or environments without departing from the spirit and scope of the present invention. For instance, in some implementations, the conveyor subroutine may comprise the first conveyor 52 and the second conveyor 54 being continuously driven following deposit of an initial parcel onto the first conveyor 52, thus eliminating the need for the conveyor subroutine to be carried out in subsequent iterations of the parcel transfer routine.

As another example, in alternative embodiments in which the second conveyor 54 includes two belt conveyors in parallel, the conveyor subroutine may involve first indexing one of the two belt conveyors of the second conveyor 54 a predetermined distance and then indexing the first conveyor 52 and both belts of the second conveyor 54 a predetermined distance.

Further, in some embodiments, the controller 110 of the vision and control subsystem 100 may be further operably connected to the extendible conveyor 12 via a wired or wireless connection, such that the controller 110 can communicate instructions to regulate the transition of the extendible conveyor 12 between an extended and a retracted configuration and to drive the conveying surfaces of the respective telescoping sections 14, 15, 16, 17, 18 of the extendible conveyor 12. In such embodiments, the conveyor subroutine may thus further involve the controller 110 communicating instructions which index the conveying surface of some or all of telescoping sections 14,15, 16, 17, 18 of the extendible conveyor a predetermined distance.

In some embodiments and implementations, prior to the controller 110 determining whether a selected parcel is within the field of view of the first camera 121 to confirm successful transfer of the parcel, the controller 110 may verify successful engagement of the selected robot with the selected parcel by assessing whether the selected robot is properly engaged with the selected parcel. Accordingly, in some embodiments, the end effector 70 of the first robot 60 and the end effector 90 of the second robot 80 each include a vacuum sensor (not shown). The vacuum sensor of each robot is operably connected to the controller 110, such that the vacuum sensor provides vacuum pressure feedback to the controller 110, which the controller 110, in turn, utilizes to determine whether the end effector of the selected robot is properly engaged with the selected parcel. If the controller 110 determines that the end effector of the selected robot is not engaged with the selected parcel, then the controller 110 will communicate instructions which cause the above-described parcel transfer routine to be repeated. Otherwise, the system 10 will proceed to verify whether the selected parcel was successfully transferred and delivered to the transfer conveyor 50 by executing the operations described above with respect to decisions 246 and 248 in FIG. 5.

Following the transfer of an initial parcel from the cargo area 22 onto the transfer conveyor 50, the parcel transfer routine described above with reference to FIG. 5 is repeated until all parcels within the cargo area 22 are transferred by the mobile robot assembly 40.

After the final iteration of the parcel transfer routine (i.e., upon the controller 110 determining the termination condition has been satisfied in decision 228 in FIG. 5), the controller 110 may communicate instructions which cause the first conveyor 52 and the second conveyor 54 to be driven a predetermined distance to ensure all parcels have been offloaded onto the extendible conveyor 12. As parcels are unloaded from the proximal end 12a of the extendible conveyor 12, and the telescoping sections 14, 15, 16, 17, 18 of the extendible conveyor 12 are retracted, the mobile robot assembly 40 follows the extendible conveyor 12 out of the cargo area 22, through the loading bay 30, and back into the building. To monitor the progression of the extendible conveyor 12 out of the cargo area 22, following the final iteration of the parcel transfer routine, the one or more sensors 48 of mobile base 42 may be activated to obtain and transmit readings indicative of the proximity of the distal end 12b of the extendible conveyor 12 to the mobile robot assembly 40 to the controller 110 for subsequent processing. Subsequent to receiving readings indicative of the distal end 12b of the extendible conveyor 12 moving further away from the mobile robot assembly 40, the controller 110 will communicate instructions which cause the one or more drive motors 46 of the mobile base 42 to drive the mobile robot assembly 40 backwardly through the cargo area.

As should be clear from the preceding discussion, in the exemplary embodiments described herein, the mobile robot assembly 40 is an autonomous mobile robot which, once activated, can perform the operations described herein for the mobile robot assembly 40 substantially free of human intervention.

Although the mobile robot assembly 40 and system 10 are primarily described herein in the context of unloading parcels from a cargo area, alternative implementations are also contemplated in which the mobile robot assembly 40 and system 10 are used to load parcels into a cargo area. In such implementations, subsequent to determining the cargo area 22 is accessible to the mobile robot assembly 40, the controller 110 will receive and process readings from the one or more sensors 48 and/or process image data received from the vision unit 120 and communicate instructions to the one or more drive motors 46 based on the same to position the mobile robot assembly 40 in a central position of the cargo bay furthest from the loading bay 30 to maximize the amount of parcels that can be loaded into the cargo area 22. The telescoping sections 14, 15, 16, 17, 18 of the extendible conveyor 12 will then be extended so that the distal end 12b of the extendible conveyor 12 is in close proximity to the transfer conveyor 50. Once the distal end 12b of the extendible conveyor 12 is in position, the conveying surface of those telescoping sections 14, 15, 16, 17, 18 defining a pathway from the proximal end 12a of the extendible conveyor 12 to the transfer conveyor 50 are then driven to transfer parcels loaded onto the proximal end 12a of the extendible conveyor 12 toward the distal end 12b of the extendible conveyor 12 and eventually onto the transfer conveyor 50.

In the above alternative implementation, instead of the transfer conveyor 50 being driven as to transfer parcels loaded thereon toward the extendible conveyor, the transfer conveyor 50 is instead driven in the opposite direction so that parcels offloaded onto the second conveyor 54 by the extendible conveyor 12 are directed onto the first conveyor 52. The first robot 60 and the second robot 80 then engage and transfer parcels received on the first conveyor 52 to a designated location in the cargo area 22. In this regard, the first robot 60 and the second robot 80 will transfer parcels from the transfer conveyor 50 to the cargo area 22 based on instructions communicated from the controller 110, such instructions preferably being based on image data received from the vision unit 120 corresponding to images obtained by one or more of the cameras 121, 123, 125, 127, 129 of the vision unit 120 (e.g., the first camera 121) of parcels located on the transfer conveyor 50. As one portion of the cargo area 22 (e.g., an area immediately adjacent to the back wall) becomes filled with parcels by the first robot 60 and the second robot 80, the extendible conveyor 12 will retract and the mobile robot assembly 40 will move backwardly toward the loading bay 30 so that additional parcels can be placed in a new, unfilled area of the cargo area 22. The above-described process can be repeated until the cargo area 22 is completely filled with parcels or all parcels in intended for loading have been loaded into the cargo area 22.

Furthermore, although the transfer conveyor 50 is primarily described herein in the context of being a component of the mobile robot assembly 40, alternative embodiments and implementations are contemplated in which the transfer conveyor 50 is a separate component from, and moves independently of, the mobile robot assembly 40. Alternative embodiments and implementations are also contemplated in which the extendible conveyor 12 is positioned within sufficient proximity to the mobile robot assembly 40 so as to permit the first robot 60 and the second robot 80 to transfer parcels from the cargo area 22 directly onto the distal end 12b of the extendible conveyor 12, thereby alleviating the need for the transfer conveyor 50 altogether. In such embodiments and implementations, the controller 110 will receive and process image data corresponding to images obtained by the one or more cameras 121, 123, 125, 127, 129 and selectively communicate instructions to the first robot 60 and the second robot 80 which cause the first robot 60 and the second robot 80 to transfer parcels located in the cargo area 22 to the extendible conveyor 12 based on the image data. Further, in such embodiments and implementations, the extendible conveyor 12 may be extended through the central opening 58 defined by the framework 55 and further extended as the mobile robot assembly 40 advances in the cargo area 22 to maintain such orientation. Further, in such embodiments and implementations, the transfer conveyor 50 may be substituted with a platform which is mounted on top of the mobile base 42 and on which or slightly above which the extendible conveyor 12 can be positioned to receive parcels transferred by the first robot 60 and the second robot 80. In some embodiments, the dimensions of the body 43 of the mobile base 42 may be sufficient to serve as such a platform. In some implementations, the mobile robot assembly 40 may, alternatively, transfer parcels located at the distal end 12b of the extendible conveyor 12 into the cargo area 22.

One of ordinary skill in the art will recognize that additional embodiments and implementations are also possible without departing from the teachings of the present invention. This detailed description, and particularly the specific details of the exemplary embodiments and implementations disclosed herein, are given primarily for clarity of understanding, and no unnecessary limitations are to be understood therefrom, for modifications will become obvious to those skilled in the art upon reading this disclosure and may be made without departing from the spirit or scope of the invention.

What is claimed is:

1. A mobile robot assembly for unloading parcels from a cargo area, comprising:
a mobile base for repositioning the mobile robot assembly within the cargo area;
a framework mounted to the mobile base;
a first robot mounted for vertical movement with respect to the framework and configured to engage and transfer parcels within the cargo area;
a second robot mounted for vertical movement with respect to the framework and configured to engage and transfer parcels within the cargo area; and
a vision and control subsystem operably connected to the first robot and the second robot, the vision and control subsystem including
one or more cameras for acquiring images of parcels located in the cargo area, and
a controller including a processor for executing instructions stored in a memory component to (i) receive and process image data corresponding to the images obtained by the one or more cameras and (ii) selectively communicate instructions to the first robot and the second robot which cause the first robot and the second robot to transfer parcels located in the cargo area based on the image data.

2. The mobile robot assembly of claim 1, and further comprising:
a first actuator operably connected to the vision and control subsystem and configured to reposition the first robot along the framework; and
a second actuator operably connected to the vision and control subsystem and configured to reposition the second robot along the framework;
wherein the memory component further includes instructions, which, when executed by the processor, cause the controller to (iii) selectively communicate instructions to the first actuator to reposition the first robot along the framework based on the image data and (iv) selectively communicate instructions to the second actuator to reposition the second robot along the framework based on the image data.

3. The mobile robot assembly of claim 1, wherein the first robot includes a first robotic arm and a first end effector for engaging parcels mounted to a distal end of the first robotic arm, and wherein the second robot includes a second robotic arm and a second end effector for engaging parcels mounted to a distal end of the second robotic arm.

4. The mobile robot assembly of claim 3, wherein each of the first robotic arm and the second robotic arm is a six-axis articulating robotic arm.

5. The mobile robot assembly of claim 3, wherein the first end effector includes a first array of vacuum cups, and wherein the second end effector includes a second array of vacuum cups.

6. The mobile robot assembly of claim 5,
wherein the vision and control subsystem is operably connected to a vacuum control subsystem, the vacuum control subsystem configured to selectively place each of the vacuum cups of the first array of vacuum cups in fluid communication with a vacuum source and to selectively place each of the vacuum cups of the second array of vacuum cups in fluid communication with the vacuum source, and
wherein the memory component further includes instructions, which, when executed by the processor, causes the controller to (iii) selectively communicate instructions to the vacuum control subsystem to place one or more vacuum cups of the first array of vacuum cups and/or the one or more vacuum cups of the second array of vacuum cups in fluid communication with the vacuum source.

7. The mobile robot assembly of claim 3, wherein the one or more cameras of the vision and control subsystem includes a first camera mounted to the first end effector and a second camera mounted to the second end effector.

8. The mobile robot assembly of claim 1, wherein the one or more cameras of the vision and control subsystem include at least one camera mounted to the framework.

9. The mobile robot assembly of claim 1, and further comprising:
a transfer conveyor, wherein the transfer conveyor is mounted to at least one of the mobile base and the framework, such that the transfer conveyor is moved as the mobile base is repositioned in the cargo area.

10. The mobile robot assembly of claim 1, wherein the mobile base includes one or more sensors operably connected to the vision and control subsystem and configured to obtain readings regarding a presence of objects within a field of view of the one or more sensors, and wherein the memory component includes instructions which, when executed by the processor, cause the controller to (iii) selectively communicate instructions to the mobile base which cause the mobile base to reposition the mobile robot assembly within the cargo area based on at least one of the image data and the readings obtained by the one or more sensors.

11. The mobile robot assembly of claim 10, wherein the mobile base includes omnidirectional wheels.

12. A mobile robot assembly for transferring parcels in a cargo area, comprising:
a transfer conveyor;
a mobile base for repositioning the mobile robot assembly within the cargo area;
a framework mounted to the mobile base;
a first robot mounted for vertical movement with respect to the framework and configured to engage and transfer parcels from at least one of the cargo area to the transfer conveyor and the transfer conveyor to the cargo area;
a second robot mounted for vertical movement with respect to the framework and configured to engage and transfer parcels from at least one of the cargo area to the transfer conveyor and the transfer conveyor to the cargo area;
a first actuator configured to reposition the first robot along the framework;
a second actuator configured to reposition the second robot along the framework; and
a vision and control subsystem operably connected to the first robot, the second robot, the first actuator, and the second actuator, wherein the vision and control subsystem includes
one or more cameras for acquiring images of at least one of the parcels located in the cargo area and parcels located on the transfer conveyor, and
a controller including a processor for executing instructions stored in a memory component to (i) receive and process image data corresponding to the images obtained by the one or more cameras, (ii) selectively communicate instructions to the first actuator to reposition the first robot along the framework based on the image data, (iii) selectively communicate instructions to the second actuator to reposition the second robot along the framework based on the image data, and (iv) selectively communicate instructions to the first robot and the second robot which cause the first robot and the second robot to transfer parcels based on the image data;
wherein the first robot includes a first robotic arm and a first end effector for engaging parcels mounted to a distal end of the first robotic arm; and
wherein the second robot includes a second robotic arm and a second end effector for engaging parcels mounted to a distal end of the second robotic arm.

13. The mobile robot assembly of claim 12, wherein the one or more cameras of the vision and control subsystem includes a first camera mounted to the framework, a second camera mounted to the first end effector, and a third camera mounted to the second end effector.

14. A system for unloading parcels from a cargo area, comprising:
an extendible conveyor configured to extend and retract to affect a length of the extendible conveyor and to convey parcels from a distal end of the extendible conveyor to a proximal end of the extendible conveyor;
a transfer conveyor for conveying parcels loaded thereon to the distal end of the extendible conveyor; and
a mobile robot assembly, including
a mobile base for repositioning the mobile robot assembly within the cargo area,
a framework mounted to the mobile base,
a first robot mounted for vertical movement with respect to the framework and configured to engage and transfer parcels within the cargo area onto the transfer conveyor,
a second robot mounted for vertical movement with respect to the framework and configured to engage and transfer parcels within the cargo area onto the transfer conveyor, and
a vision and control subsystem operably connected to the first robot and the second robot, the vision and control subsystem including
one or more cameras for acquiring images of parcels located in the cargo area, and
a controller including a processor for executing instructions stored in a memory component to (i) receive and process image data corresponding to the images obtained by the one or more cameras and (ii) selectively communicate instructions to the first robot and the second robot which cause the first robot and the second robot to transfer parcels located in the cargo area onto the transfer conveyor based on the image data.

15. The system of claim 14, wherein the mobile robot assembly further includes
a first actuator operably connected to the vision and control subsystem and configured to reposition the first robot along the framework; and
a second actuator operably connected to the vision and control subsystem and configured to reposition the second robot along the framework;
wherein the memory component further includes instructions, which, when executed by the processor, causes the controller to (iii) selectively communicate instructions to the first actuator to reposition the first robot along the framework based on the image data and (iv) selectively communicate instructions to the second actuator to reposition the second robot along the framework based on the image data.

16. The system of claim 14, wherein the first robot includes a first robotic arm and a first end effector for engaging parcels mounted to a distal end of the first robotic arm, and wherein the second robot includes a second robotic arm and a second end effector for engaging parcels mounted to a distal end of the second robotic arm.

17. The system of claim 16, wherein each of the first robotic arm and the second robotic arm is a six-axis articulating robotic arm.

18. The system of claim 16, wherein the first end effector includes a first array of vacuum cups, and wherein the second end effector includes a second array of vacuum cups.

19. The system of claim 18,
wherein the vision and control subsystem is operably connected to a vacuum control subsystem, the vacuum control subsystem configured to selectively place each of the vacuum cups of the first array of vacuum cups in fluid communication with a vacuum source and to selectively place each of the vacuum cups of the second array of vacuum cups in fluid communication with the vacuum source; and
wherein the memory component further includes instructions, which, when executed by the processor, causes the controller to (iii) selectively communicate instructions to the vacuum control subsystem to place one or more vacuum cups of the first array of vacuum cups and/or the one or more vacuum cups of the second array of vacuum cups in fluid communication with the vacuum source.

20. The system of claim 16, wherein the one or more cameras of the vision and control subsystem includes a first camera mounted to the first end effector and a second camera mounted to the second end effector.

21. The system of claim 14, wherein the one or more cameras of the vision and control subsystem include at least one camera mounted to the framework.

22. The system of claim 14, wherein the transfer conveyor is mounted to at least one of the mobile base and the framework, such that the transfer conveyor is moved as the mobile base is repositioned in the cargo area.

23. The system of claim 14, wherein the mobile base includes one or more sensors operably connected to the vision and control subsystem and configured to obtain readings regarding a presence of objects within a field of view of the one or more sensors, and wherein the memory component includes instructions which, when executed by the processor, cause the controller to (iii) selectively communicate instructions to the mobile base which cause the mobile base to reposition the mobile robot assembly within the cargo area based on at least one of the image data and the readings obtained by the one or more sensors.

24. The system of claim 23, wherein the mobile base includes omnidirectional wheels.

25. A system for unloading parcels from a cargo area, comprising:
an extendible conveyor configured to convey parcels and to extend and retract to affect a length of the extendible conveyor; and
a mobile robot assembly, including
a mobile base for repositioning the mobile robot assembly within the cargo area,
a framework mounted to the mobile base;
a first robot mounted for vertical movement with respect to the framework and configured to engage and transfer parcels within the cargo area onto the extendible conveyor,
a second robot mounted for vertical movement with respect to the framework and configured to engage and transfer parcels within the cargo area onto the extendible conveyor, and
a vision and control subsystem operably connected to the first robot and the second robot, the vision and control subsystem including
one or more cameras for acquiring images of parcels located in the cargo area, and
a controller including a processor for executing instructions stored in a memory component to (i) receive and process image data corresponding to the images obtained by the one or more cameras and (ii) selectively communicate instructions to the first robot and the second robot which cause the first robot and the second robot to transfer parcels located in the cargo area onto the extendible conveyor based on the image data.
